(19) United States
(12) Patent Application Publication
(10) Pub. No.: US 2004/0098706 A1
(43) Pub. Date: May 20, 2004

(54) Component-based software distribution and deployment

(76) Inventors: Kashaf N Khan, Ipswich (GB); Alan P Smith, Ipswich (GB); Benjamin Bappu, Ipswich (GB); Jean WC See, Ipswich (GB); Steven Rudkin, Ipswich (GB); George Papamargaritis, Ipswich (GB)

Correspondence Address: Nixon & Vanderhye, 8th Floor, 1100 North Glebe Road, Arlington, VA, 22201-4714, US

(21) Appl. No.: 10/469,351

(22) PCT Filed: Mar. 14, 2002
(86) PCT No.: PCT/GB02/01167

(30) Foreign Application Priority Data
Mar. 28, 2001 (EP) 01302895.6

(51) Int. Cl. G06F 9/44; G06F 15/16

(52) U.S. Cl. 717/120; 717/115; 709/201

(57) ABSTRACT

A Component-based Software Distribution Channel allows Component Service Providers (10) to advertise component services via a Service Directory (12) to service developers. The component services are advertised in a format which encapsulates a legally binding contract which must be accepted before the components may be incorporated into a client service. The service developer may combine together a number of different component services to create a combined client service. That service may be announced in a Session Directory (16) in an encapsulated format which incorporates a legally binding agreement which must be accepted by a client before the resultant session may be accessed.

The present invention relates to the field of component-based software distribution and deployment. More specifically, it relates to a software distribution channel that may make use of sessions. Although by no means restricted to this application, the invention may be applied to the provision of broadband services, such as multicast audio and video.

There has been for a number of years increasing interest in the use of Component-based Software Engineering techniques to support the reuse of common software components in the development of new applications. Recently, efforts have been made to apply such techniques to the announcement and deployment of session-based services, such as IP multicast audio and video services. Recent work in this field is described in published patent applications WO-A-0033535 and WO-A-0036804, both in the name of British Telecommunications plc. Further details are given in Rudkin, Steve and Smith, Alan: A Scheme for Component Based Service Deployment, published in Trends in Distributed Systems Towards a Universal Service Market, 3^{rd} International Conference IFIP/GI, USM 2000, September 2000, page 68.

In this earlier work, individual program components were made available by Component Service Providers who used a Service Directory to advertise their component services to other service providers. A service provider could take the components from the Service Directory, combine them in any desired way and add session-specific information to create a session announcement. The service provider could then advertise the resultant sessions in a Session Directory, accessible to the ultimate customer. The customer could select a session (for example an IP multicast of a particular movie), download the details and locally build the application necessary to receive and view that particular movie.

The present invention derives from a generalisation and improvement of the methods and systems disclosed in the publications mentioned above.

According to a first aspect of the invention there is provided a method of creating application service announcements, comprising:

(a) selecting a plurality of component services descriptions, each component service description defining a component service having one or more components;

(b) creating an application template based on the selected component service descriptions; and

(c) repeatedly re-using the application template to create a plurality of application service announcements.

The invention enables third parties to offer service components to a service provider community. Service providers can preferably search and retrieve component services, to provide the functionality they need, and then “glue” them together to create an application template which can be used to create many services. The invention enables the component service functionality to be mainly based at the client, or alternatively at the enterprise side with the inter-component binding being based at the client (that is, at the terminal of the end user or customer).

More generally, the invention extends to a component-based service for the provision, composition and deployment of applications; Preferably, the following features are included:

Service creation: The generation of a component service description specifying user related data, service behaviour in terms of component functionality and remote service attributes (such as media address, port and bandwidth), a component composition template, and constraints on service behaviour by the use of charging and security policies.

Service development: The composition of component services according to their behavioural specifications such as session, component and policy interface. The generation of a composite component service to be delivered to the end user.

Service deployment: Deployment of a given composite component service to the end user according to its component composition template, local or remote component availability, and component configuration according to remote service attributes and policy constraints.

Preferably, component service functionality is distributed between the client and the enterprise end. For example, in a dynamic payment gateway service there may be a component located at the client end which uses a server component at the enterprise end to process transactions.

Component service function may be parameterised by remote service attributes. In addition, service functions may be constrained by contractual terms of agreement between service providers (for example charging and security policies) and clients (for example relating to best component runtime performance and resources utilisation requests).

The invention may support both open and closed business models. Closed models may be accommodated by restricting access to particular communities using standard security mechanisms. Alternatively, an open model can be implemented by removing access restrictions, so that any third party may use the service directory.

The present invention provides great flexibility in the creation of component-based applications and services. The flexibility goes far beyond the ability simply to bundle components or services together. The ultimate application is composed not only from combinations of pre-existing components or services (possibly modified during the composition) but also from an additional overlying structure which may incorporate enforceable policies over and above the policies of the individual components or services. The application service announcements may preferably be session announcements (for example for audio or video media sessions, or game sessions). Each session announcement may be created from the application template plus additional session-specific information. In one example, a service provider could use a common template for the delivery of video on demand services, with a specific session announcement being created for each individual movie.

When the application template is being created from the selected component service descriptions, additional application-specific information may be incorporated. In the above example, the application template may include details of the service provider, so that users can easily identify which movies are being supplied by which provider.

The component service descriptions may include a contractually-binding component agreement, and it is preferred that that component agreement must be accepted by a creator of the application template before he or she is allowed to proceed with the creation of a service and the production of application service announcements. The component agreement preferably includes a component interface, a session interface, charging and security policies.

The component agreement is preferably directed to the service provided/developer, but it is also possible for the agreement to be directed to the end user. In such a case, it is preferred that the agreement has to be accepted by the user before the application service may be used.

A second contractually-binding agreement is preferably incorporated into the application service announcement by the service provider, and is addressed to the end user. In the preferred embodiment, this application agreement has to be accepted by a user who wishes to use the application service, before the application service may be used. The application agreement may take the same or a similar form to the component agreement, and in particular it may include a charging policy.

The charging policy incorporated into the or both agreements may include or specify the location of a charging component, the purpose which is to interpret the charging policy and to facilitate payment. The charging component may require the service provider and/or the end user makes a payment (for example by credit card) before the component service description or the application service, respectively, may be used.

Both the application service announcements and the component service descriptions are preferably constructed from a common structured data format such as XML. Using XML, the component service descriptions are preferably defined by means of a Component Service Descriptor (CSD), while the application service announcements are preferably defined by means of Service Announcement Format (SAF).

The component service descriptions may be stored and made available to application providers within a directory service or a federation of directory services. The service directory may be implemented by means of a Lookup Service (LUS), including a security service, a component store and a description store.

The invention in one form extends to a method of creating application service announcements including the prior step of creating the individual component service descriptions, and making those descriptions available for selection.

The invention further extends to a method of service delivery including creating application service announcements according to the method described above, advertising the application service announcements to an end user, selecting one of the announcements and creating an executable application therefrom. The step of creating the executable application may include the steps of parsing the said application service announcement, determining which component services are required, downloading any component services that are unavailable locally, binding the components, and running the resultant application.

In one embodiment, there may be a component service registration process which restricts access to third party component service providers who wish to advertise on the service directory. The service federation, where applicable, can be restricted so that component service advertisements are available only to certain communities within the federation, or to none at all.

A security service provider may be incorporated into the invention providing security components including authentication, privacy and integrity.

The invention extends to a computer program or to an executable set of instructions for implementing a method as previously described. It further extends to a computer-readable carrier which carries a computer program or executable set of instructions as previously mentioned.

According to a further aspect of the present invention there is provided a software distribution channel comprising:

(a) a service directory for storing a plurality of component service descriptions, each component description defining a component service having one or more components;

(b) an application template builder for creating an application template based on the selected component service descriptions; and

(c) an application builder for repeatedly re-using the application template to create a plurality of application service announcements.

The invention further extends to a computer system incorporating a software distribution channel as previously described and/or to a computer system for creating application service announcements as previously described.

The invention may be carried into practice in a number of ways and one specific embodiment will now be described, by way of example, with reference to the accompanying drawings, in which:

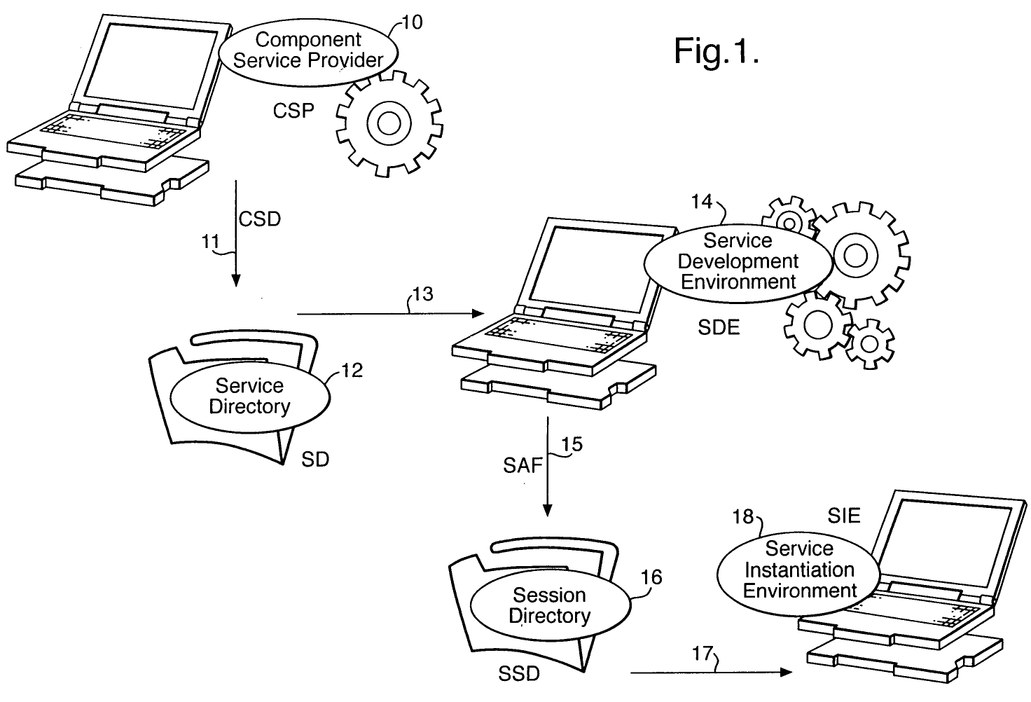

FIG. 1 shows an overview of the preferred embodiment;

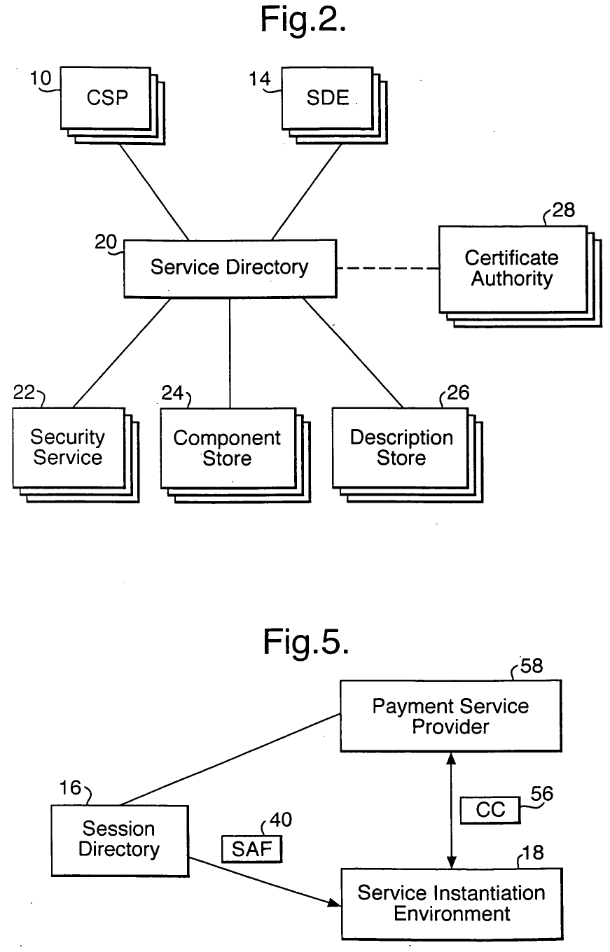

FIG. 2 illustrates the Service Directory;

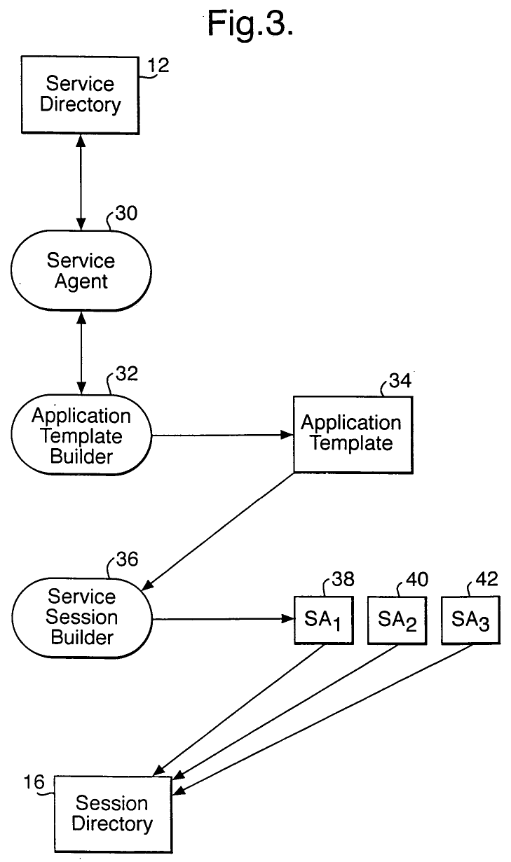

FIG. 3 shows the operation of the Service Development Environment;

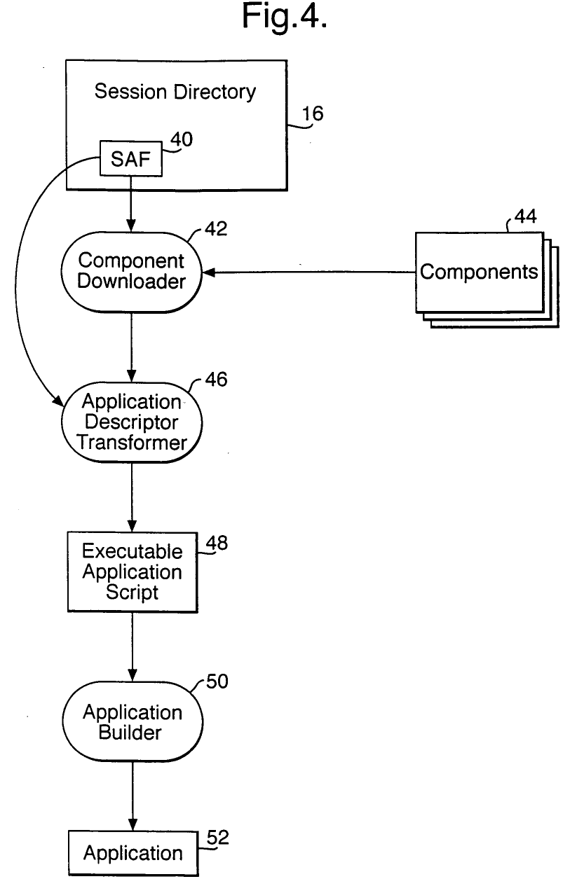

FIG. 4 shows the operation of the Service Instantiation Environment; and

FIG. 5 shows the interactions with a Payment Service Provider.

In the description below, the preferred embodiment of the invention will be referred to by the name given to it within British Telecommunications plc., namely “COMPOSE”. COMPOSE is a channel for component software distribution, and service creation, which stretches from initial component production right through to final instantiation of the resultant service by the customer. It provides an infrastructure for supporting service providers to promote their own component services for use by third parties, and also for supporting service developers who may wish to have rapid access to “best of breed” components written by others.

An overview of COMPOSE is shown in FIG. 1. The channel starts with the Component Service Provider (CSP) 10 whose task is to write and to make available to service providers reusable software components.

Each component is described by a Component Service Descriptor (CSD) and, as indicated by the arrow 11, is placed by the Component Service Provider into a Service Directory (SD) 12 from where it may be selected by service providers.

A service provider wishing to provide a software service to a consumer, downloads the necessary components from the Service Directory 12, as indicated by the arrow 13, and, within a Service Development Environment (SDE) 14, “glues” them together to create a service application template.

Typically, the service provider will add additional functionality to the service, over and above that provided by the various components that have been taken from the Service Directory 12. The application template is used to create a variety of individual session announcements, each session announcement including not only the template information but also additional session-specific information. As indicated by the arrow 15, the session announcements are then uploaded by the service provider into a Session Directory 16. Session announcements are described in Service Announcement Format (SAF).

An end user or customer, wishing to make use of a service which is announced in the Session Directory 16, downloads the corresponding SAF file, as indicated by the arrow 17 into the Service Instantiation Environment (SIE) 18. This will typically be the end user's PC or other computer system.

A program running on the SIE 18 parses the statements within the SAF file to determine which components are necessary to implement the service. If the appropriate components are not already stored on the SIE, the system downloads them as appropriate, for example across the Internet, and then binds them together to create the final application which may then be executed in the usual way.

While COMPOSE in its broadest form may be used for all types of component software distribution and service creation, in one embodiment it may be used to enable the provision of broadband services such as multicast audio and video services to the customer. In that example, the service provider may for example be in the business of supplying multicast movies. He uses the system to develop a generic template, which will be used for all movies, and he then uses that as the basis for creating the individual movie session announcements. Each movie session announcement includes the basic information about the components to be used, along with session-specific information such as the name of the movie, the IP multicast address, the port, and the media format. This information, when downloaded by the user, provides the SIE 18 with everything it needs to create and execute the movie-viewing program, and to find and handle receipt of the media stream.

In the embodiment of FIG. 1, service reuse may occur at two different stages. Firstly, service providers may reuse individual components which have been supplied by the Component Service Provider, and made available on the Service Directory 12. Secondly, the template created by the service provider in the Service Development Environment 14 allows reuse of services and/or components within multiple sessions as announced in the Session Directory 16. In either case, the reuse is entirely transparent to the end user, who simply selects and makes use of any of the session announcements contained within the Session Directory 16. In the specific example given above, the session announcements listed in the Session Directory may be video-on-demand listings, the selection of any one of those listings allowing the customer access to the corresponding video steam without any need to understand, or even to know about, the individual components that are being used or the additional functionality provided by the service provider.

The specific implementation of the embodiment shown in FIG. 1 will now be described in more detail. We will start with a description of the Component Service Descriptor (CSD), the purpose of which is to define and encapsulate the attributes and characteristics of the components supplied by the Component Service Provider 10.

The Component Service Descriptor (CSD) defines not only the attributes of each component, but also represents and encapsulates a legally-binding contractual agreement between the component supplier (the CSP 10) and the user of the component (normally the Application Service Provider, operating within the SDE 14). In making use of a particular component, and incorporating it within a service which is going to be offered to customers, the Application Service Provider becomes party to and becomes bound by the contractual agreement incorporated within the CSD.

Alternatively, the contractual agreement within the CSD may be between the Component Service Provider 10 and the ultimate customer at the SIE 18. In such a case, the ultimate customer would become bound by the agreement when selecting and/or attempting to use a service which includes that particular component. Of course, it would be possible for the CSD to represent a three-way contractual agreement, requiring acceptance both by the service provider and also by the ultimate customer before the component is capable of being used within an application on the SIE.

The Component Service Descriptor is preferably implemented in XML, and includes the following information:

Component interface: the contract states what other client components have to do to use the interface, and what a third party provider must implement to meet the service which has been promised by the component provider.

Session interface: the contract sets out the resources (media and functionality) which the component service is authorised to use. For example, the contract may permit the use of a specific IP address to download a movie.

Policies: the contract specifies what the policies are for use of the service. Policies explain, for example, how the client will be charged (the “charging policy”), and how the client will be authorised to use the service (the “security policy”).

The component interface, session interface and policies, as advertised on the Service Directory 12, enable the application service provider to identify the appropriate component services and to set up interactions between them, thereby establishing a composite component service.

In addition to the above, the Component Service Descriptor also encapsulates implementation details, dependencies to software and hardware resources, mechanisms for accessing the provisioning services, and a mechanism for locating the component to the network and downloading and installing it to the client's machine.

In more detail, the Component Service Descriptor comprises an XML file including the following elements:

(a) Basemodule; this provides general information for a component;

(b) Componentmodule: this contains the individual components that may be built up into a composite service;

(c) Service: this describes the component service interface via a set of methods and variant conditions that constrain the methods execution;

(d) Implementation: this is responsible for the implementation specification of the component service;

(e) Service dependency: this describes the dependencies of the service to other software and hardware resources;

(f) Policy: this links to charging and security XML descriptors, which illustrate the charging and security policies which are applied to the respective component service; and

(g) SessionInterface: this includes those attributes that allow the session provider to configure the attributes of a session.

To elucidate these elements more fully, we will now describe an example which assumes the advertisement of a realplayer component service used for streaming real-time content (for example video or audio). Realplayer is a Java-based component, which uses at a lower level the JMF component framework, as well as other Java components to implement media player services.

The CSD starts with a route element, as shown in listing 1, below:

Listing 1: component service_descriptor root element

<!ELEMENT service_descriptor (basemodule, componentmodule?,
service,
implementation+, service_dependency?, policy, sessionInterface)>

The basemodule, shown in Listing 2, provides general information for the realplayer component including the ID, name, version, category, service description and details for the owner of the component:

Listing 2: basemodule

<basemodule>

<id>realplayer</id>
<name>Real Player</name>
<version>v01</version>
<category>real player</category>
<service description>a Real Player service</
service_description>
<icon

href=“http://www.jungle.bt.co.uk/projects/compose/metadata/
descriptors/icons/projector.gif”></icon>

<owner>

<name>

Distributed Systems Group

</name>
<contact email=“” phone=“” fax=“”>
</contact>

</owner>

</basemodule>

The basemodule provides an overview of the component service as an independent entity. Other responsibilities include the following:

Helps to classify the component service in the Service Directory 12. For example, version discriminates different versions of the same (realplayer) component; category classifies, for instance, realplayer under a media player component category; and id uniquely identifies the component.

Enables the service developer to search for announced component services in the Service Directory and to allow for the differences between alternative components.

The componentmodule (see listing 3) encapsulates information for the plugin components that will build the entire component service. For each component, the component module advises the service developer/provider of information relating to implementation, distribution and installation requirements:

Listing 3: componentmodule

<componentmodule>

<component name=“JMF”>

<implementation id=“imfimpl01”>

<os name=“win9598NT”
version=“”></os>
<processor name=“”></processor>
<compiler name=“java compiler”
version=“jdk 1.2.2”></compiler>
<programminglanguage name=“java”
version=“jdk 1.2.2”>
</programminglanguage>
<runtime name=“java runtime environment”
version=“jre 1.2.2”>
</runtime>

<implementation_location>

<setuplocation class=“JMF”>

<codebase filename=“”

href=“http://ferao.jungle.bt.co.uk/
projects/compose/download-

centre/jmf/jmf.jar” >

</codebase>

<post_install><run>java
com.real.util.RJMFConfig

</run></post_install>

</setuplocation>

</implementation_location>
<codetype>jar</codetype>
<disksize></disksize>
<memoryrequirements></memoryrequirements>
<componentQos><performance>
</performance></componentQos>

</implementation>
<service_description> </service_description>

</component>

</componentmodule>

The implementation element addresses requirements for the client machine on which the components will be installed and executed. These include the following:

the set of operating systems and their versions, which might support the component execution;

the minimum processing power required (processor) as well as storage, memory and performance requirements; and

details for the component deployment (compiler, programming language), and the runtime necessary for component instantiation.

The implementation location guides the distribution of the component from the component service provider down to the client's machine. The distribution is addressed by the codebase element, which indicates the location of the component. Then, the system will need to know what happens after the component is installed to the computer's registry. The answer is given by the codetype attribute, which explains how the component will be accessed (e.g. a jar file); the run attribute, which indicates the final configuration of the component at the client's machine (e.g. java com.real.util.JMFConfig); and the class attribute, which indicates the main object which instantiates the component (e.g. JMF).

It should be noted that CSD may be used to describe not only individual components, but also component services (i.e. services which consist of two or more components). Where there is more than one component within the component service, the component element will be repeated within the component module as many times as necessary.

The service element, illustrated by Listing 4, represents one of the three contractual states of a component, namely the component interface. In this way, the component interface may be separated from its implementation, allowing the abstraction of the service component behaviour at a higher level while hiding implementation details:

Listing 4: service element

<service name=“jrpservice”>

<codebase filename=“”

href=“http://ferao.jungle.bt.co.uk/
projects/compose/download-

centre/real.jar”></codebase> <method mname=
“setMediaFile”>

<input> <type> String </type>

<constraint></constraint>
<service_description>The media
file</service_description>

</input>
<output> <type></type>

<constraint></constrain<service_description>
</service_description>

</output>
<service_description>
</service_description>

</method>
<method mname=“go”>

<input>

<type></type><constraint></constraint>
<service_description></service_descri
ption>

</input>
<output>

<type></type><constraint></constraint>
<service_description></service descri
ption>

</output>
<service_description>It streams
an audio/video file

</service_description>

</method>

</service>

The service developer will access information for the services a component offers in order to build a combined service of more than one component services connected via their interfaces. The role of the service element is to:

retain the location of the component interface (codebase) remotely. For instance, the file realjar stores the interface of the realplayer component. It is used for introspecting the methods, events, properties the realplayer makes available to an application.

indicate the parameters and the constraints which characterise each of the methods of the interface. The interface methods provided by a component are considered the facade of the component to the outside world and a key mechanism of interaction with other component services. A method has a name (mname), input and output parameters and an actual description of its role in the interface. Before a method is invoked it is necessary to know the types of its input and output parameters, any constraints applied on them, and their role in the method. In general, the method features (e.g. method constraints) of a component interface may but need not be exploited within COMPOSE.

Service dependency describes any external resource component that the individual components of the composite service will depend on for their deployment and instantiation (eg a java class, a dll, or another resource). The service dependency description is similar to the component implementation specification given above. In addition, a comname attribute is used to recognize uniquely a resource component. The codebase of the resource component interface might be specified if it is to be accessed through an interface.

The policy element links both to charging and security XML descriptors, which prescribe the charging and security models to be applied to this particular component.

The purpose of the charging policy is to capture details allowing the system to charge users for service usage, and to set up a legally binding contract between service providers and their users. The charging policy holds the necessary details of a charging service contract, that could either be bundled or unbundled. These terms are described below:

A bundled charging service contract determines a legal relation between the various entities involved such that:

a customer pays its service provider who provides the overall service,

the service provider pays its individual component service providers for using the individual component services, the service provider pays the customer's network provider for network access, and

the service provider pays its network provider for network access.

An unbundled charging service contract determines a legal relation between the various entities such that:

a customer pays the service provider who provides the overall service,

the customer pays the individual service providers for their individual component services,

the customer pays its network provider for network access, and

the service provider pays its network provider for network access.

COMPOSE supports the provision of both bundled and unbundled service contracts.

The charging policy (part of the policy element) comprise a charging description, the tariff packages it offers, the payment methods, and references to any dependent policies that also require payments. An example is shown in Listing 5 which follows:

Listing 5: charging element

<charging type=“unbundled”>

<description>

<name>Audio-Video Player</name>
<validity>

<start-time> <date day=“1” month=“8”
year=“2000”/> </start-time>
<end-time> <date day=“31” month=“12”
year=“2001”/> </end-time>

</validity>

</description>
<tariff-package>

<tariff>

<flat-rate> <fee>1.00</fee> <when
type=“prepay”/></flat-rate>
<time-of-use unit=“hour”>
<fee>0.50</fee> <when type=“postpay”/>

</time-of-use>

</tariff>
<currency type=“GBP”/>

<validity> <start-time> <date day=“1” month=
“8” year=“2000”/>

</start-time>

<end-time> <date day=“31” month=“12”
year= “2001”/> </end-time>

</validity>

</tariff-package>
<payment>

<payment-method>

<mechanism name=“BuyNet”/>
<payment-gateway>

<location> <address>132.146.129.68
</address><port>8000</port>

</location>

</payment-gateway>

</payment-method>
<payee> <merchantID>1234567891</merchantID> </payee>

</payment>

</charging>

The description may include details such as the type of policy (bundled or unbundled), along with details of the validity of the policy.

The tariff-package may specify different pricing models, such as flat rate or time charge. Users could also be charged on the basis of how much traffic is requested and generated: the same tariff could apply to both downloaded and uploaded traffic, or different tariffs could be applied. Combinations of the above would also be possible.

The payment entry specifies the type of payment method, such as using a particular payment server at a particular address and port number.

The references to other charging policies may comprise a link to charging policies of dependent service components.

The second part of the policy element is the security policy. The application developer/service provider uses the security element to obtain security certificates which verify the Component Service Provider who has supplied this particular component. An example of a security element, within the policy element, is set out in Listing 6, below:

Listing 6: security element

<security cert_store_location=“132.146.107.63” cert_store_port=“4003”
merchant_ID=“kash” service_ID=“realplayer”>
</security>

The security element includes information for accessing the certificate (including server location and port) as well as perameters for authorising the communication between service providers and developers (merchant_ID, service_ID).

The session interface element defines the interface between third parties and service providers. Session attributes are dynamically defined in the session interface to configure the communication between the client components and the associated remote services. For instance, in Listing 7 (below), the realplayer component has to configure the value of a mediaFile parameter with the remote address of the video file which will be delivered through the component instantiation:

Listing 7: sessionInterface element

<sessionInterface>

<sessionAttr name=“mediaFile”

value=“http://www.jungle.bt.co.uk/projects/compose/media/bwp.mpg”/>
</sessionInterface>

Turning now to FIG. 2, there is shown in more detail the structure of the Service Directory (SD) 12 of FIG. 1. The Service Directory consists of a core service 20 along with a number of other registered services, namely a security service/store 22, a component store 24 and a description store 26. The core service 20 provides access for the service users, namely the Component Service Providers 10 and the Service Developers at the SDEs 14.

In this model, all of the elements 20 to 26 represent services, and the service directory itself has minimal direct functionality. A Service Developer at the SDE who wishes to make use of the Directory first registers with the core service 20, which provides a list of the local service providers, i.e. the services 22,24,26. One of those is selected, and the user is then presented with a further list supplied by the local service.

By permitting each local service to register as proxies in the core service 20, where they can be downloaded and used by either a CSP 10 or an SDE 14, the SD model may be quite small and dynamic.

The Description Store 26 holds the service descriptions, which may be viewed as an object (XML) database. The store includes functionality for adding, removing and querying objects within the database e.g. by means of keyword searches. Each service description within the database is conveniently signed by the service provider.

The Component Store 24 acts like a web server and, as its name suggests, simply stores components. To execute the service, the user downloads the components from a designated Component Store. Each component has a unique identify generated by the component provider.

The Security Service 22 provides the necessary authorisation, authentication and certification services. For example, the Component Store at start-up may require a digital certificate that establishes its credentials when its services are invoked. The Service Developer can use the security service to obtain the certificates to verify the Component Store, for example from a Certificate Authority 28. Likewise, each component in a Component Store can be certified, to ensure that they are from a trusted third party, and that they are safe to execute on the client machine.

In use, the Component Service Provider 10 will first register the description of the component in a Description Store 26, and will upload the packaged component to a Component Store 24. Alternatively, the Component Provider could use his own Component Store, and define a link to it as part of the description. The package will typically include digital signatures and certificates.

The Service Directory preferably implements a Java JINI-based Lookup Service (LUS), which handles the registration, discovery and distribution of services. The LUS multicasts its presence on TCP IP networks to form a federation of Lookup Services, which advertise services to all the other Lookup Services within the federation. To access a service, the client or service developer downloads the LUS registrar object, and invokes the desired function (for example to find a service). The client then creates service templates to search for services based on unique IDs, types and/or objects. When successful, the LUS registrar will return one or more service proxies which may be downloaded to the developer's machine. This uses its own private and secure protocol to interact directly with the required service.

It will be understood of course that although the CSP 10 will frequently be advertising individual components on the Service Directory, the Service Directory could also be used for the advertisement of more complex component services, namely services which combine two or more individual components. Such component services may be accessed and used by the Service Developer as a distinct entities in their own right.

FIG. 3 shows the Service Development Environment (SDE) 14 of FIG. 1.

The SDE enables a service developer to find and retrieve the “building block” components needed, which are then “glued together” to form an application which is described in Service Announcement Format (SAF)— see below. Firstly, the SDE enables retrieval and matching of component services from the Service Directory 12, and secondly it encapsulates service generation and delivery.

A Service Agent 30 enables service developers to search the Service Directory 12 for advertised components or component services which will together form the combined application.

Once all the component services have been found, an Application Template Builder 32 is used to glue them together. This involves first customising the state of each service component, tailoring the component more specifically to the functionality required by the service, then organising the component services in order of execution, and binding them together using an event-based messaging mechanism. The result is an Application Template 34 which can be used as a “cookie cutter” to create many individual services.

Next, the developer uses a Service Session Builder 36 to create individual service announcements 38,40,42 from the Application Template 34. Each service announcement includes the template information along with additional session-specific information (for example telling the resultant application where to locate and how to deal with multicast content).

During preparation of the Application Template 34, or during preparation of the individual Session Announcements 38,40,42, additional information may be incorporated by the service provider, including information about the service provider itself, and contractual policies covering charging and security. These policies, which may apply to all of the service announcements based on a particular template, or only some of them, are in addition to the charging and security policies which are applicable to the individual components or component services which underlie the service announcement.

The individual service announcements 38,40,42 are described in Service Announcement Format (SAF), and are then deployed to the Session Directory 16 from which customers can retrieve the service offers.

Service Announcement Format (SAF) is used to describe the individual session announcements, and includes all of the information necessary to facilitate the customer's access to the actual service—for example access to the remote media sessions. SAF comprises the following modules:

A base module which prescribes user-oriented data for a given service (for example service name, owner, available media and time information);

A component service module which provides information for each of the component services making up the service application. A SAF description includes links to component service descriptors used to prescribe the session attributes, application component specifications and policy constraints of a component service. In general, the Component Service Module represents the resources (content and distributed functionality) necessary for delivering the overall service to the end user;

A component wiring module which specifies how the components interact and their order of execution; and

a policy module which specifies how the overall service should be charged, and how system security is implemented. As mentioned above, this policy module describes overall policies which are applicable in addition to the individual component policies.

The template-specific or the session-specific charging and security policies, added by the service developer, are described within SAF in a similar manner to the way in which those policies are described for individual component services within CSD. More particularly, the charging and security policies preferably comprise a collection of XML elements which are inserted into the CSD or into the SAF. Alternatively, it would be possible to use a link to a policy descriptor stored elsewhere: that approach would mean that any modification to the charging XML document would not affect the component or the session description. In the preferred COMPOSE embodiment, however, the former non-linked approach is used for simplicity.

The SAF description created by the service provider acts as a contractual agreement between the service provider and the user. In addition, it may also have encapsulated within it a contractual agreement between the Component Service Provider and the user.

The Service Instantiation Environment (SIE) 18 is shown in more detail in FIG. 4.

The SIE is responsible for downloading an SAF file 40 from the Session Directory 16 and producing from it a running application. From the SAF 40, the SIE uses the Service Descriptor modules and the wiring module in order to produce the application. The input into the application building process include the session, the available components and the charging and security policies of the overall service, as described in the SAF. Also, the application template in the wiring module provides details of the component configuration.

Once the user has decided to join a session, and the SAF file has been downloaded, it is passed to a Component Downloader 42 which checks which components are already installed on the local computer, and which components and their dependencies remain to be installed. The descriptor of each component service provides all the necessary information about component location and dependencies, enabling the component loader to locate and to download additional components 44 as necessary.

Once all the components are available, an Application Descriptor Transformer 46 uses them, along with input session attributes from the SAF, to product an Executable Application Script 48. Finally, this is converted by an Application Builder 50 into a Running Application 52.

When the available sessions are displayed to the user via the Session Directory 16, both the description of the available sessions and their associated charges are displayed. The charges are computed by a Charging Component (described below) which forms part of the service and which performs its calculations on the basis of the component charging policies and/or the session charging policies.

As shown in FIG. 5, the SAF file 40 for a particular session is downloaded into the Service Instantiation Environment 18 from the Session Directory 16. The SIE, in order to parse the charging policies, requires a Charging Component 56. Typically, such a component will be provided by a Payment Service Provider 58 and, if not already available in the SIE, will automatically be downloaded from an address specified in the SAF file. Alternatively, the SAF may simply include a pointer to the Payment Service Provider to be used, that provider specifying where the charging component may be downloaded from.

The Charging Component 56 will typically include functionality providing for direct communication between the user and the Payment Service Provider, for example the transfer of credit card information. The user must provide the necessary information before the application can be run.

Each entity within the system is preferably certified by a Certificate Authority, such as the Authority 28 shown in FIG. 2. Not only does the Application Developer use the Security Service to obtain certificates to verify Component Service Providers, but all communications between the Component Service Providers, the Application Developers, and the ultimate customer are encrypted.

Finally, all stored entities (both components and descriptions) are signed.

1. A method of creating application service announcements, comprising:
(a) selecting a plurality of component services descriptions, each component service description defining a component service having one or more components;
(b) creating an application template based on the selected component service descriptions; and
(c) repeatedly re-using the application template to create a plurality of application service announcements.

2. A method as claimed in claim 1 in which the application service announcements are session announcements, each session announcement being created from the application template plus additional session-specific information.

3. A method as claimed in claim 1 or claim 2 in which the session announcement announces an audio or video media session, or a game session.

4. A method as claimed in any one of the preceding claims in which the application template includes the selected component service descriptions plus additional application-specific information.

5. A method as claimed in any one of the preceding claims in which the component service descriptions include a contractually-binding component agreement.

6. A method as claimed in claim 5 in which the component agreement must be accepted by a creator of the application template before application service announcements may be created.

7. A method as claimed in claim 5 in which the component agreement must be accepted by a user who wishes to use the application service, before the application service may be used.

8. A method as claimed in any one of claims 5 to 7 in which the component agreement defines a charging policy which defines how use of the component service description, or use of the corresponding component service, will be charged.

9. A method as claimed in any one of the preceding claims in which the application service announcements include a contractually-binding application agreement.

10. A method as claimed in claim 9 in which the application agreement must be accepted by a user who wishes to use the application service, before the application service may be used.

11. A method as claimed in claim 9 or claim 10 in which the application agreement defines a charging policy which defines how use of the application will be charged.

12. A method as claimed in claim 8 or claim 111 in which the application service announcement includes a charging component, or a pointer to a charging component, the charging component interpreting the charging policy and facilitating payment.

13. A method as claimed in any one of the preceding claims in which the application service announcements and the component service descriptions are constructed from a common structured data format.

14. A method as claimed in claim 13 in which the structured data format is Extensible Mark-up Language (XML).

15. A method as claimed in any one of the preceding claims including the step of selecting the component service descriptions by searching a service directory in which the descriptions are advertised.

16. A method as claimed in claim 15 in which the searching is carried out within a federation of service directories.

17. A method as claimed in claim 15 or claim 16 including storing components corresponding to the component service descriptions in a component store of the service directory.

18. A computer program for implementing a method as claimed in any one of the preceding claims.

19. A computer-readable carrier carrying a computer program as claimed in claim 18.

20. A software distribution channel comprising:
(a) a service directory for storing a plurality of component service descriptions, each component description defining a component service having one or more components;
(b) an application template builder for creating an application template based on the selected component service descriptions; and
(c) an application builder for repeatedly re-using the application template to create a plurality of application service announcements.

21. A software distribution channel as claimed in claim 20 in which the application service announcements are session announcements, the application template builder creating each session announcement from the application template plus additional session-specific information.

22. A software distribution channel as claimed in claim 20 or claim 21 in which the session announcement announces an audio or video media session, or a game session.

23. A software distribution channel as claimed in any one of claims 20 to 22 in which the application template builder uses the selected component service descriptions plus additional application-specific information to create the template.

24. A software distribution channel as claimed in any one of claims 20 to 23 in which the component service descriptions include a contractually-binding component agreement.

25. A software distribution channel as claimed in claim 24 in which the component agreement must be accepted prior to the creation of application service announcements by the application builder.

26. A software distribution channel as claimed in claim 24 in which the component agreement must be accepted by a user who wishes to use the application service, before the application service may be used.

27. A software distribution channel as claimed in any one of claims 24 to 26 in which the component agreement defines a charging policy which defines how use of the component service description, or use of the corresponding component service, will be charged.

28. A software distribution channel as claimed in any one of claims 20 to 27 in which the application service announcements include a contractually-binding application agreement.

29. A software distribution channel as claimed in claim 28 in which the application agreement must be accepted by a user who wishes to use the application service, before the application service may be used.

30. A software distribution channel as claimed in claim 28 or claim 29 in which the application agreement defines a charging policy which defines how use of the application will be charged.

31. A software distribution channel as claimed in claim 28 or claim 30 in which the application service announcement includes a charging component, or a pointer to a charging component, the charging interpreting the charging policy and facilitating payment.

32. A software distribution channel as claimed in any one of claims 20 to 31 in which the application service announcements and the component service descriptions are constructed from a common structured data format.

33. A software distribution channel as claimed in claim 32 in which the structured data format is Extensible Mark-up Language (XML).

34. A software distribution channel as claimed in any one of claims 20 to 33 including a service directory in which the component service descriptions are advertised, and means for selecting the component service descriptions from the service directory.

35. A software distribution channel as claimed in claim 34 including a federation of service directories.

36. A software distribution channel as claimed in claim 34 or claim 35 in which the service directory includes a component store for storing components corresponding to the component service descriptions.
